(19) United States
(12) Patent Application Publication
(10) Pub. No.: US 2025/0114818 A1
(43) Pub. Date: Apr. 10, 2025

(54) Coating Apparatus with Oscillating Nozzle

(71) Applicant: Automatic Coating Limited, Toronto (CA)

(72) Inventors: Brad BAMFORD, Scarborough (CA); Keith ROBB, Scarborough (CA); Marek BUDNICKI, Toronto (CA); Ashish LAKOD, North York (CA)

(21) Appl. No.: 18/906,881

(22) Filed: Oct. 4, 2024

Related U.S. Application Data
(60) Provisional application No. 63/587,948, filed on Oct. 4, 2023.

(51) Int. Cl. B05C 19/00; B05C 19/02

(52) U.S. Cl. CPC B05C 19/008; B05C 19/02

(57) ABSTRACT

A transfer and coating apparatus transfers a component from a conveyor to a coating station for application of a coating. The transfer apparatus includes a mast that can move about orthogonal axes in a horizontal plane and a mast having a carriage that can move vertically. The carriage includes a hook that swings about a horizontal axis relative to the mast for movement of the component in the horizontal direction. A sway bar extends between the hook and component to inhibit movement about a horizontal axis. The component is delivered to an upper compartment of a coating apparatus where it can be lowered in to a lower compartment containing coating material. Excess coating material is removed by an array of nozzles in the upper compartment as the component is raised from the coating material. The orientation of the nozzles is adjustable during removal of the coating material.

### FIELD OF THE INVENTION

The present invention relates to a method and apparatus for applying a coating to a component.

### SUMMARY OF THE INVENTION

Most fabricated articles require a coating to be applied to protect them against the environment in which they will operate. One of the most demanding environments is salt water, as encountered on seagoing vessels, in which mechanisms and components must be protected again the corrosive effects of the salt carried in the sea water. The maintenance of the components is an expensive and continuous process. Painting or coating of components is performed prior to exposure, but even then frequent replacement of intricate components where salt water may be trapped is necessary.

One particular application that has proven difficult to properly maintain is the sealing systems found on watertight doors used on seagoing vessels. The seals are contained within a channel formed from a lip of the door and a weldment to contain the seal. This construction provides various crevices in which protective coatings are difficult to apply and in which seawater tends to collect in use leading to rapid corrosion of the seal system and failure of the door.

It is known to apply coatings through the use of fluidized beds to components as shown for example in U.S. Pat. No. 6,444,032. The coating of a door assembly with a seal retention system does however pose further challenges, in particular because of the intricate nature of the seal retention system.

To ensure a uniform and penetrating coating to a component, such as a door, it has been found effective to agitate the component within the fluidised bed as the component is immersed and retracted. U.S. Pat. No. 9,802,218 describes a method and apparatus in which a component is supported on a hook as it is lowered in to a fluidised bed. A drive acts on the hook to cause bodily movement of the component within the fluidised bed with abrupt reversals in direction. The agitation produced is effective to inhibit bridging of the coating to ensure proper penetration.

In the above disclosure, the hook is mounted on a carriage that is moveable vertically along a mast. The mast is supported on an overhead conveyor for movement in a horizontal plane and can rotate about a vertical axis to adjust the position of the hook. The agitation is provided directly from an air cylinder that is controlled by a valve that effects the abrupt changes in direction. This arrangement has proven highly effective in providing a penetrating coating to a complex surface but requires significant intervention during transfer to control movement of the component and also imposes significant loading on the support for the mast. Moreover, removal of excess coating requires a separate processing station which adds to the complexity and footprint of the apparatus.

U.S. Pat. No. 10,730,068 discloses a door coating machine in which the above issues are addressed. The hook is arranged to rotate about a vertical axis to position the door relative to the conveyor and fluidised bed and thereby avoids the need to rotate the mast as it translates in a horizontal plane.

Air jets are also incorporated into the chamber above the fluidised bed to impinge on the door as it is lifted from the fluidised bed and remove excess coating. The operation of the jets is co-ordinated with the lifting of the door to ensure proper removal of the excess coating.

It has been found however that although the basic construction of the doors to be processed is similar, there are many variations from door to door. Some doors may, for example, have windows and associated framing and others for example may utilise T-section framing rather than angle section. These variations make it difficult to remove of excess coating in a uniform manner and maintain an acceptable surface finish.

It has also been found that the use of the air jets suspends the coating within the upper chamber and causes a build up of the coating material on the surrounding structure. In particular the operating components of the door that encloses the fluidised bed may become coated and not function as required and components of the conveyor system may likewise be impacted by the airborne coating material.

### OBJECT OF THE INVENTION

It is therefore an object of the present invention to obviate or mitigate the disadvantages found in prior systems.

### STATEMENT OF INVENTION

According to one aspect of the present invention there is provided a coating apparatus including a first compartment to receive a component to be coated, a second compartment below said first compartment to contain a coating material, a carriage assembly to lower said component from said first compartment to said second compartment for application of coating and to lift said component from said second compartment after application of coating, and a blow off apparatus to remove excess coating material from component, said blow off apparatus including a first array of nozzles in said first compartment to project a fluid toward said component as it is raised from said second compartment to remove excess coating material from said component, said first array of nozzles including at least one set of nozzles mounted to oscillate and vary the direction of projection of said fluid toward said component.

According to a further aspect of the present invention there is provided a coating apparatus including a first compartment to receive a component to be coated, a second compartment below said first compartment to contain a coating material, and a carriage assembly to lower said component from said first compartment to said second compartment for application of coating and to lift said component from said second compartment after application of coating, said first compartment having a front wall, side walls and a rear wall and a ceiling extending between said walls to divide said first compartment into an upper cavity and a lower cavity, said front wall having an door opening to permit ingress and egress of a component to be coated and a door assembly moveable between an open position in which components may be inserted in to or removed from the first compartment and a closed position in which access to said first compartment is inhibited, said door assembly having a pair of doors each slidably supported on a bearing assembly extending about the periphery of said compartment and moveable along said bearing assembly between said open position and said closed position, and a drive to move said doors along said bearing assembly, said drive and said bearing assembly located above said ceiling to separate said drive and bearing from said lower cavity of said first compartment.

According to a still further aspect of the present invention there is provided a transfer and coating apparatus comprising a transfer apparatus to deliver a component to a coating apparatus where a coating is applied to said component, said transfer apparatus comprising a conveyor track and a trolley moveable along said conveyor track to deliver said component to said coating apparatus and to forward said component from said coating apparatus to a further station, said trolley comprising a body, a set of rollers supported by said body to engage said conveyor for movement along said conveyor, and an arm depending from said body to carry said component, said body comprising a base extending beneath said conveyor, a pair of side walls extending upwardly from said base to support each of said set of rollers for rotation about a horizontal axis, a roof panel extending inwardly from each of said side walls and terminating in spaced relationship to allow passage of said conveyor therebetween and end walls extending between said roof and said base at opposite ends of said side walls and terminating adjacent to said conveyor, said body encompassing said rollers to inhibit accumulation of coating material within said body.

According to a yet further aspect of the present invention there is provided a coating apparatus having a compartment to contain a coating material to coat a component within said compartment, said compartment having side walls and a floor and an outlet positioned on one of said sidewalls to allow coating material to be removed, said floor being inclined toward said outlet at an angle of between 2° and 6° to horizontal.

### EMBODIMENTS OF THE INVENTION

Embodiments of the invention will now be described by way of example only with reference to the accompanying drawings in which:

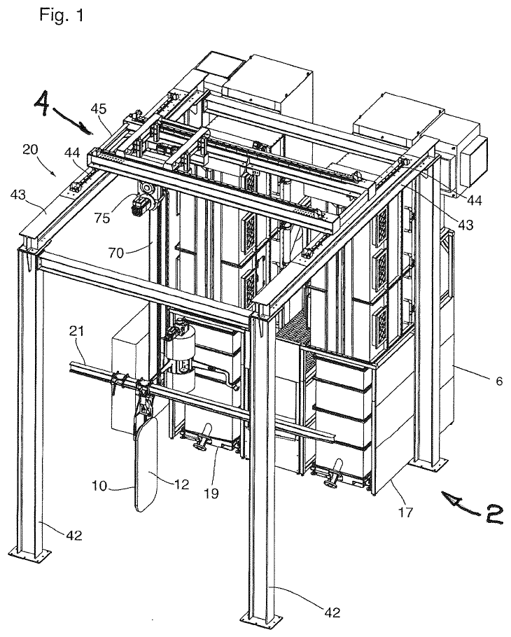

FIG. 1 is a front perspective view of a transfer and coating apparatus for coating a component;

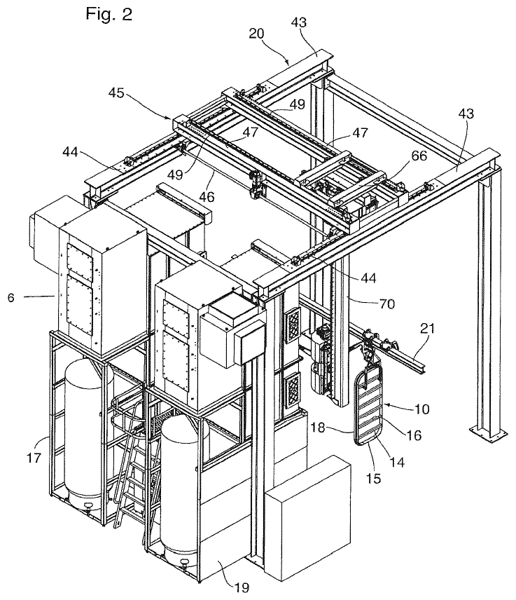

FIG. 2 is a rear perspective view of a transfer and coating apparatus shown in FIG. 1;

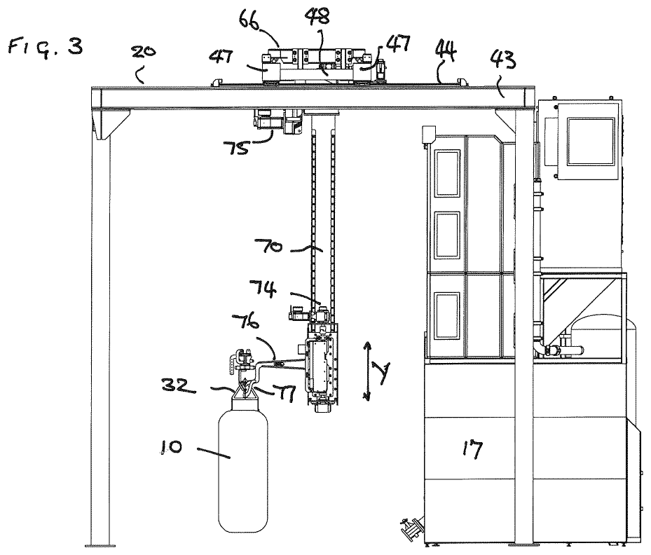

FIG. 3 is a side elevation of the transfer and coating apparatus of FIGS. 1 and 2;

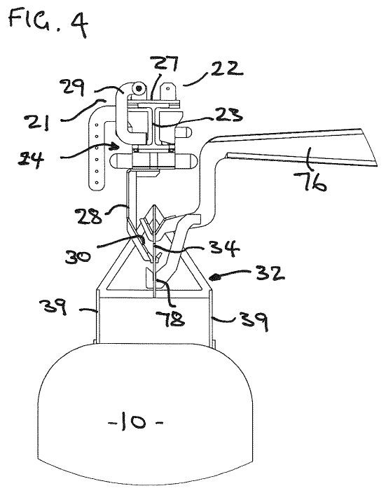

FIG. 4 an enlarged view of a portion of the apparatus within the circle C in FIG. 3;

FIG. 5 is a front perspective view of the portion of the apparatus shown in FIG. 4;

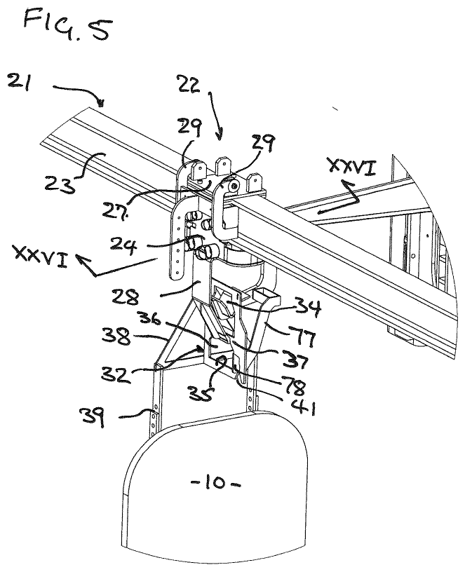

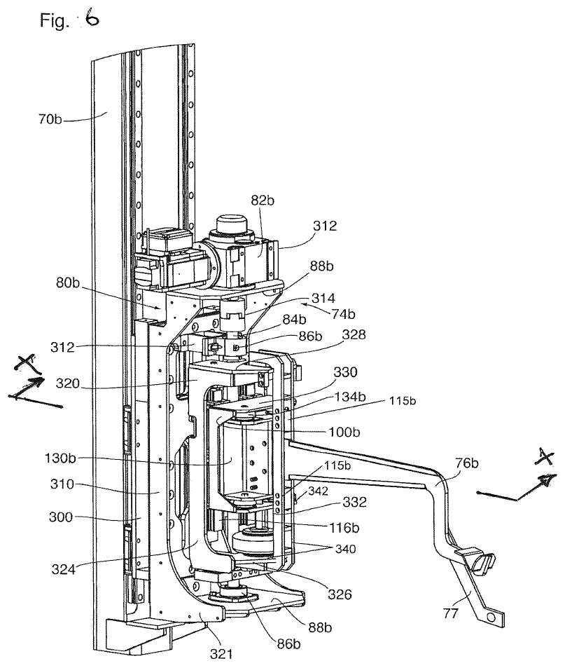

FIG. 6 is a front perspective view of a carriage for use in the transfer and coating apparatus of FIG. 1;

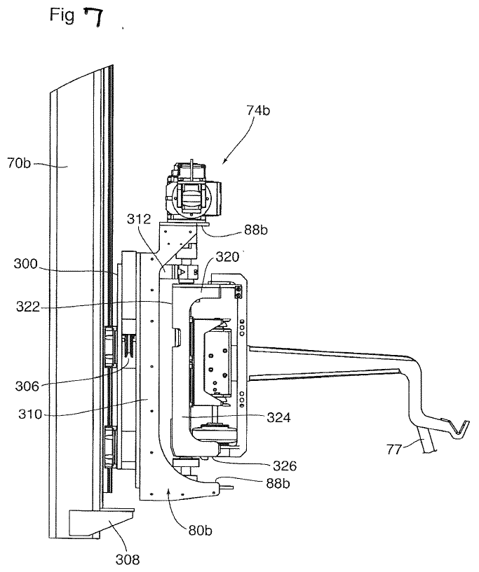

FIG. 7 is a side elevation of the carriage of FIG. 6;

FIG. 8 is a section along the line VIII-VIII of FIG. 6;

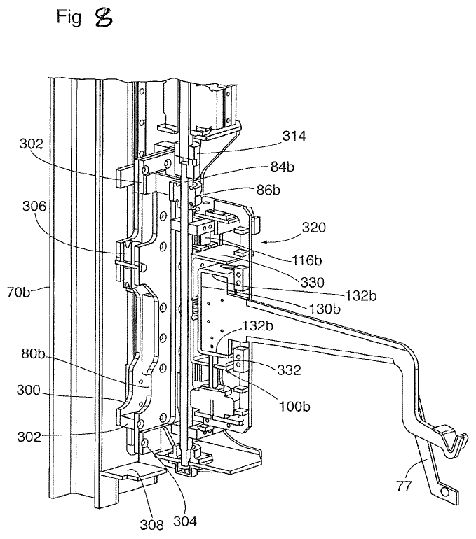

FIG. 9 is a representation of the coating station used in the transfer and coating apparatus of FIG. 1;

FIG. 10 is an enlarged side view of the lower portion of the coating station shown in FIG. 9;

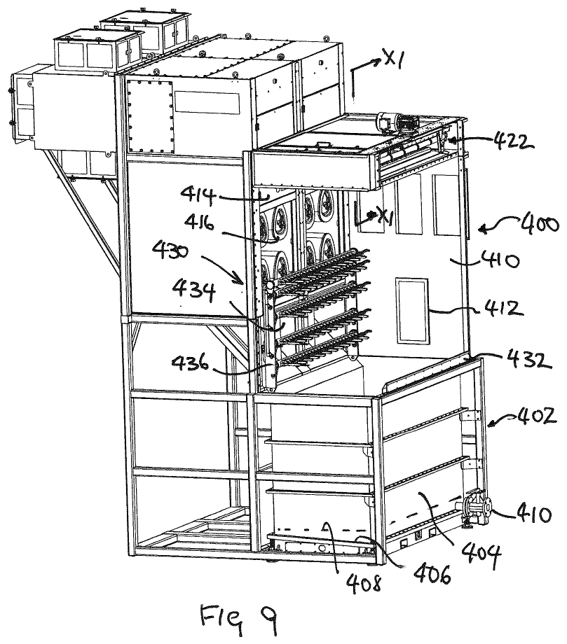

FIG. 11 is a section on the line XI-XI of FIG. 9;

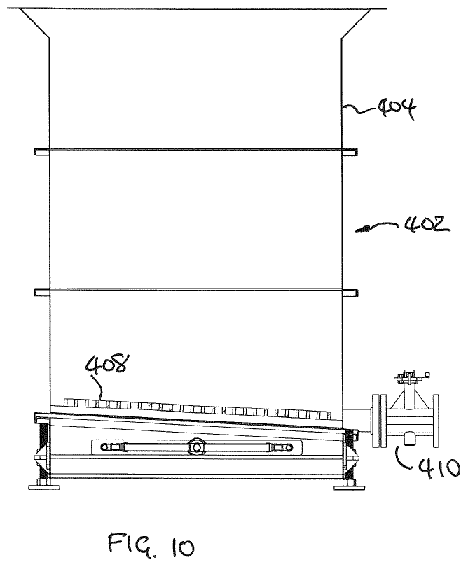

FIG. 12 is a perspective view of the components of a blow off station incorporated in to the coating station of FIG. 9;

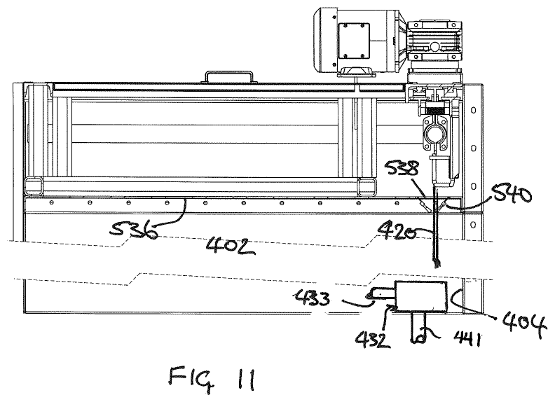

FIG. 13 is a plan view of a nozzle array of FIG. 12;

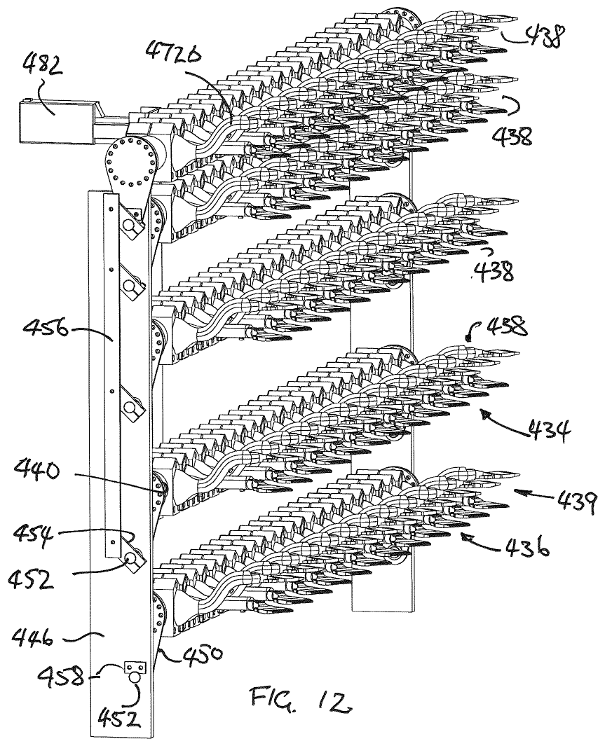

FIG. 14 is an enlarged view of the portion of FIG. 13 within the circle A;

FIG. 15 is a section on the line XV-XV of FIG. 14;

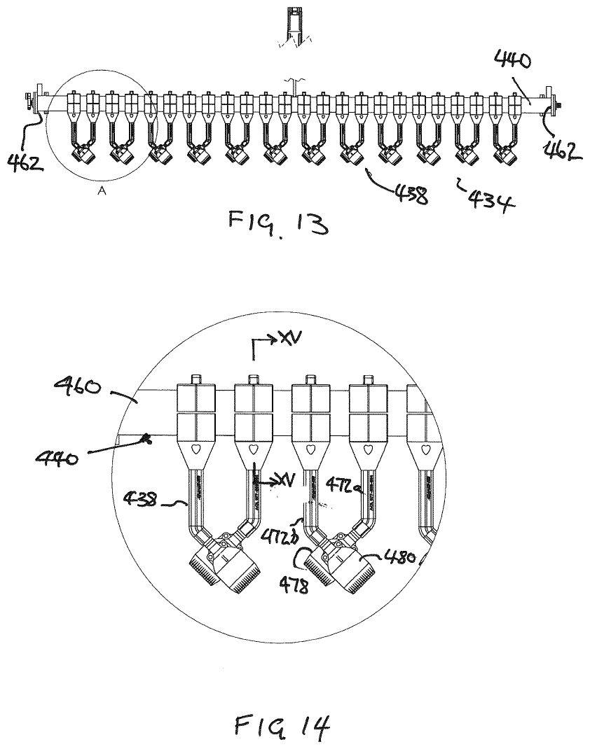

FIG. 16 is a rear view of the nozzle array shown in FIG. 12;

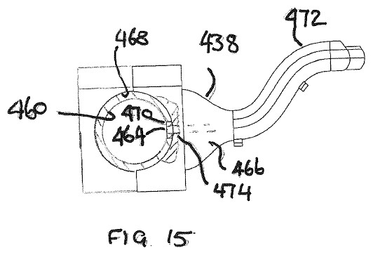

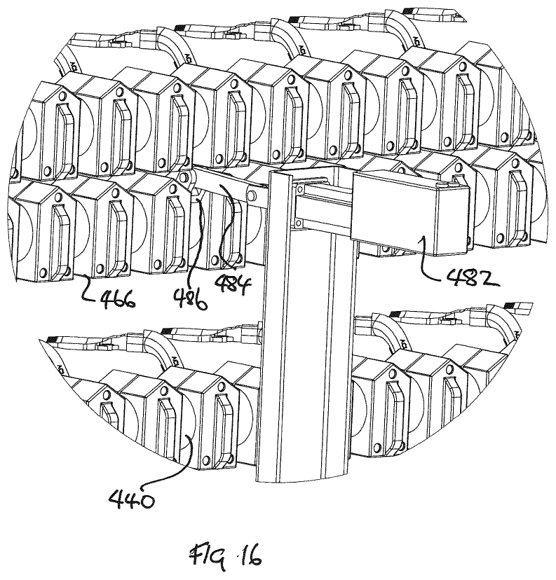

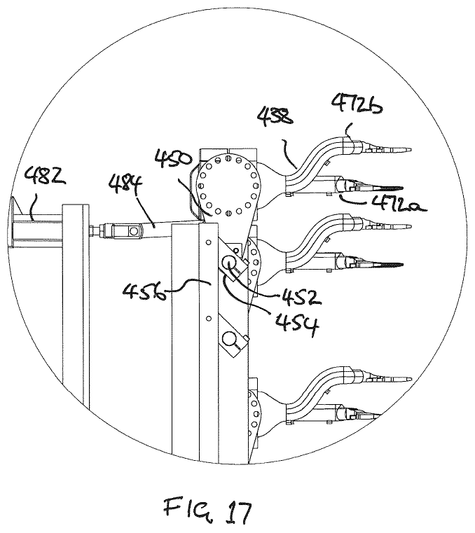

FIG. 17 is a side view of the FIG. 12 with the nozzle array in a first orientation;

FIG. 18 is a view similar to FIG. 17 with the nozzles in a second orientation;

FIG. 19 is a perspective view of the upper compartment of the coating apparatus shown in FIG. 9;

FIG. 20 is a front perspective view of the upper portion of FIG. 19;

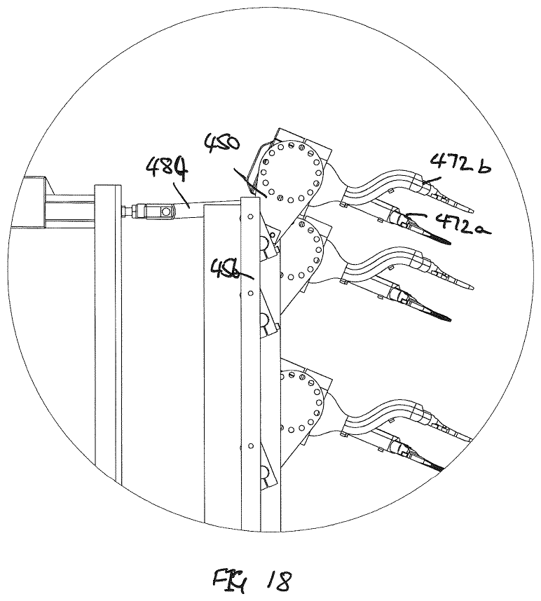

FIG. 21 is a front elevation of FIG. 20;

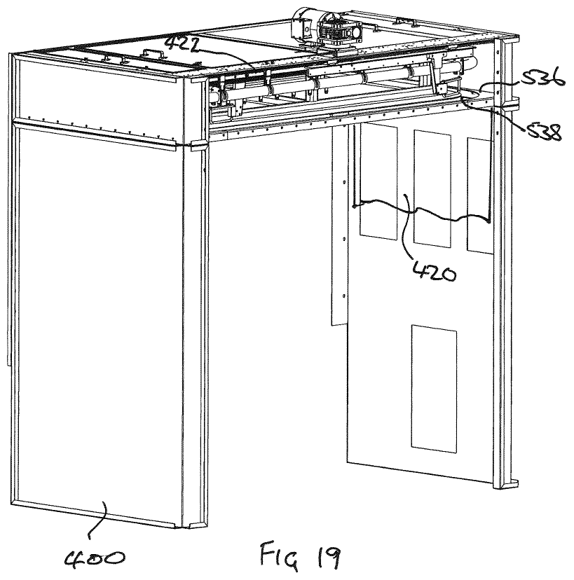

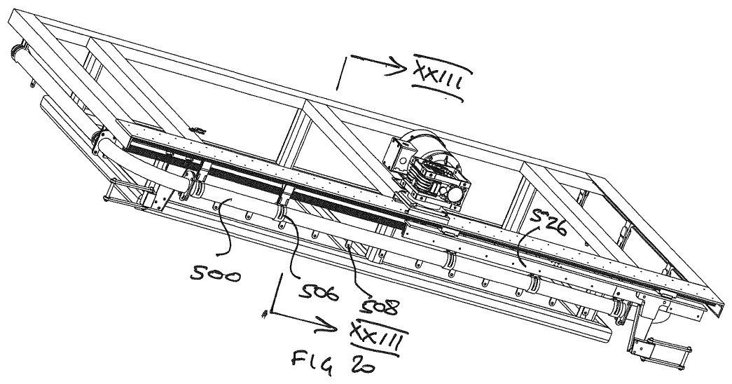

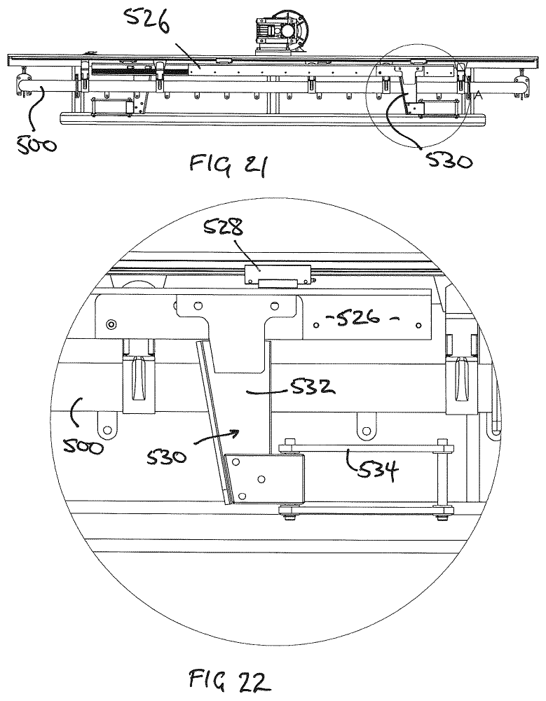

FIG. 22 is an enlarged view of the portion of FIG. 21 within the circle B;

FIG. 23 is a section on the line XXIII-XXIII of FIG. 20,

FIG. 24 is a front elevation of a door used in the coating apparatus of FIG. 9,

FIG. 25 is a view on an enlarged scale on the line XXV-XXV of FIG. 24;

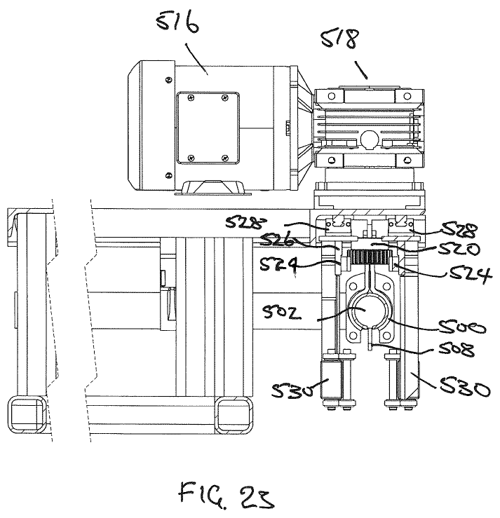

FIG. 26 is a perspective view of a trolley shown on the conveyor of FIG. 5;

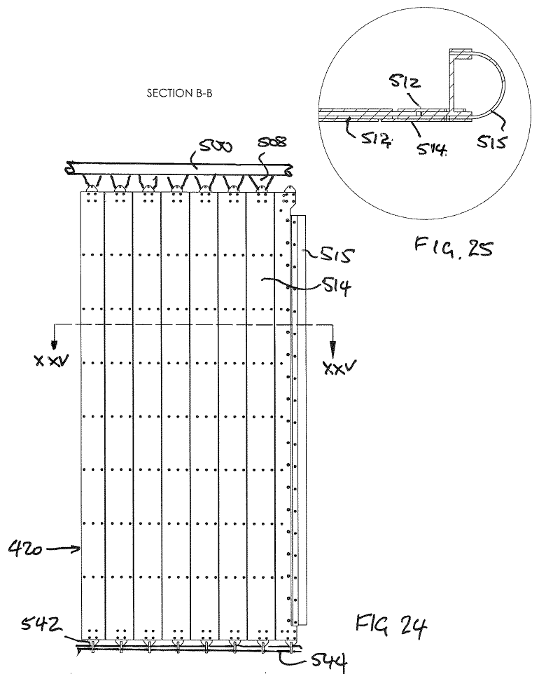

FIG. 27 is a plan view of FIG. 26;

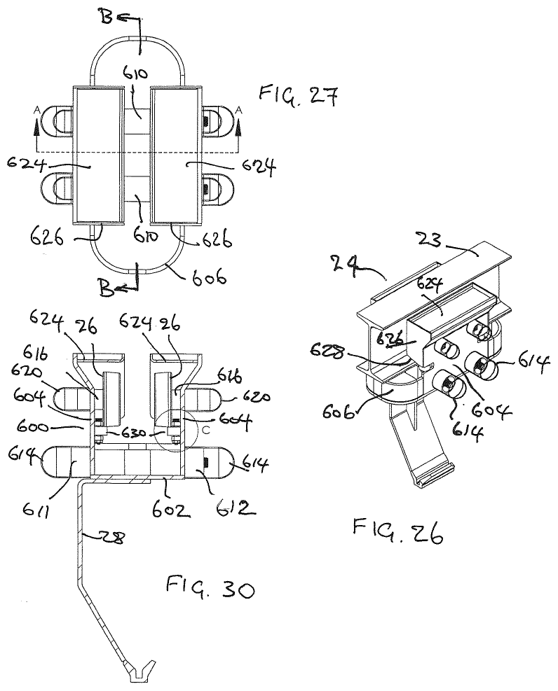

FIG. 28 is a section on the line A-A of FIG. 27;

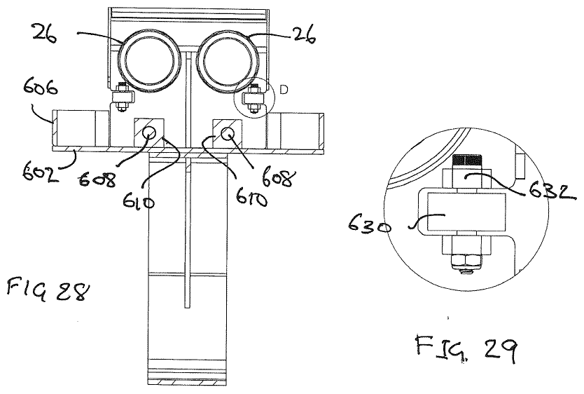

FIG. 29 is a detailed view on an enlarged scale of the component in the circle D on FIG. 28; and

FIG. 30 is a section on the line B-B of FIG. 27.

Referring firstly to FIGS. 1 and 2, a transfer and coating apparatus generally indicated 2 includes a transfer apparatus 4 and a coating apparatus 6 that are utilised to move a component 10 from a conveyor 21 and apply a coating to the component.

The component 10 that is to be coated is exemplified as a door having an outer surface 12, and a frame 14. Referring to FIG. 2 and as shown in greater detail in U.S. Pat. No. 9,802,218, the contents of which are incorporated herein by reference, the frame 14 has a peripheral frame member 15 and a cross members 16. A seal retainer 18 that carries a seal assembly is incorporated into the frame 14. The seal retainer 18 is formed as a channel in which a seal sits and has an overturned lip and a flange welded to the frame 14 to define the channel. The channel is of convoluted configuration and is therefore difficult to coat in a manner that fills the voids between the retainer 18 and the frame 14. Similarly, the cross members 16 may have re-entrant cross-sections, such as a T-section or channel, and may collect and retain fluid coating. It will be appreciated that the door is merely exemplary of the components that may be coated and is itself of known construction.

A coating is applied to the component 10 in the coating apparatus 6 which in the embodiment of FIG. 1 includes a pair of fluidised beds 17, 19, each of which contains a coating. To perform a coating process on the component 10, the component 10 is manipulated between the conveyor 21 and the beds 17, 19 by the transfer apparatus that includes an overhead gantry indicated at 20. In the arrangement shown in FIGS. 1 and 2, a pair of fluidised beds 17, 19 are arranged side by side and the component 10 is immersed sequentially in the beds 17, 19. This is merely exemplary of a typical process and it will be appreciated that only a single fluidised bed 17 may be used or that alternative processing apparatus such as an electrostatic coating process may be used rather than the second fluidised bed 19.

The components 10 are delivered to the gantry 20 on the overhead conveyor 21. Prior to delivery to the gantry 20, the component may be moved on the conveyor 21 through various ancillary stations, such as a degreaser, shot blaster and oven to prepare the component 10 for coating. Following coating, the component 10 may be returned to the conveyor 21 for transfer to another area for further processing, such as passing through a curing oven.

As can be seen in FIGS. 4 and 5, the conveyor 21 is a formed as an I-beam 23 with hanger assemblies 22 that allow components to be suspended from the conveyor 21. The hanger assemblies 22 have a trolley 24 with rollers 26 that roll along the flanges of the I-beam. The trolley 24 is held captive on the I-beam 23 by a plate 27 and pivoted clamp arms 29 that engage the trolley 24 and encompass the I-beam 23. An arm 28 depends from one side of the trolley 24 and extends under the I-beam 23 to terminate in an upturned V-shaped notch 30.

The details of the trolley 24 is more fully illustrated in FIGS. 26 to 30. The trolley 24 has a body 600 with a base 602 and a pair of upstanding side walls 604. The arm 28 is welded to the underside of the base 602 and extends below the trolley 24. The side walls 604 are supported by a pair of bolts 608 that pass through steel bushings 610 located on the base 602. The head 611 of the bolt 608 and the nut 612 secured to the bolt 608 are encompassed in silicone caps 614 to inhibit build of powder on the bolt 608.

Each of the walls 604 carries a pair of rollers 26 mounted on stub axles 616. The stub axles 616 extend through the side walls 604 and have a grease nipple to supply lubricant to the roller 26. The end of the stub axle 616 and grease nipple are covered by a silicone cap 620 to protect them from coating dust.

Each of the side walls 604 is flared outwardly at its upper end where it is connected to a roof panel 624 that projects inwardly. The roof panel 624 overhangs respective ones of the rollers 26 and each terminate inboard of the rollers 26 to provide a gap through which the web of the I-beam 23 can pass. End walls 626 extend between the roof panel 624 and the side walls 604 to enclose the rollers 26 with the lower edge 628 of the end walls 626 downwardly sloped to correspond to the slope of the flanges of the I beam 23.

The base 602 projects beyond the side walls 604 at each end with a skirt 606 projecting upwardly from the periphery of the base 602 toward the underside of the I-beam 23. The skirt 606, end walls 626 and roof panels 624 co-operate with the I beam to effectively encapsulate the rollers 26 and inhibit ingress of coating material.

Alignment rollers 630 are carried on the side walls 604 on a threaded bolt 632 that permits the alignment rollers to be aligned with the edge of the lower flange of the I-beam and inhibit lateral translation of the trolley on the I beam 23.

The component 10 is supported on the conveyor 21 by a hanger 32 that rests on the V-shaped notch 30 of the arm 28. The hanger 32 has a head 34 with a pair of apertures 35, 36 on either side of a cross bar 37. A triangular frame 38 is secured to one edge of the head 34 and extends to opposite sides. A pair of straps 39 with hooked ends depend from the frame 38 to engage the cross members 16 of the component 10. The opposite edge of the head 34 to the frame 38 has a flange 40 that lies in the plane of the head 34 with an elongate slot 41 extending upwardly from the lower edge of the head 34.

The hanger 32 is configured to facilitate transfer of component 10 from the conveyor 21 to the gantry 20. The gantry 20 can best be seen in FIGS. 1 to 3 and comprises legs 42 that support a pair of longitudinal rails 43, each extending fore and aft toward the fluidised beds 17, 19. Linear bearings 44 are provided on the upper surface of the rails 43 to support a transverse frame 45. The transverse frame 45 is moved along the bearings 44 by a layshaft 46 so the position of the transverse frame 45 can be adjusted relative to the fluidised beds 17, 19.

The transverse frame 45 has a pair of lateral rails 47 that are supported on the linear bearings 44 and are interconnected by frame members 48. Linear bearings 49 are provided on the upper surface of the lateral rails 47 to slidably support a sled 66. A drive (not shown) acts between the transverse frame and the turntable to move the sled 66 laterally relative to the fluidised beds 17, 19. The combination of the linear bearings 44, 49 and drives on the longitudinal rails 43 and lateral rails 47 allow the sled 66 to move along orthogonal axes for positioning relative to the fluidised beds 17, 19.

A mast assembly 70 extends below the longitudinal rails 43. The mast assembly 70 supports a carriage assembly 74 for movement along the axis of the mast 70 as indicated by the arrow Y and has a hoist mechanism 75 to raise and lower the carriage assembly 74. As will be described in greater detail below, the carriage assembly 74 has a hook 76 that is rotatable about a vertical axis. The hook 76 has a distal end arranged to pass through the aperture 35 in the hanger 32 and engage the upper bar of the head 34, as shown in FIGS. 3 and 4, to lift the component 10 off the notch 30. A sway bar 77 projects downwardly from one side of the hook 76 and terminates with a pair of enlarged bosses 78. The sway bar 77 is dimensioned to fit within the slot 41, which has a flared entrance to facilitate initial alignment, with the flange 40 passing between the bosses 78.

Different embodiments of carriage are shown in prior application Ser. No. 16/103,055, the contents of which are incorporated herein by reference. A preferred embodiment is included in the present application, in FIGS. 6 to 8 for completeness although it will be appreciated that alternative embodiments may be utilised if preferred. In the embodiment of FIG. 6-8, a base plate 80b that can slide along the mast 70 under the control of the hoist 75 is mounted on the mast 70b through an attachment plate 300 to facilitate removal of the carriage assembly 74 when required. Spacers 302 are interposed between the base plate 80b and attachment plate 300 and mounting bolts 304 connect the plates through the spacers 304. A pulley 306 is positioned between the plates 80b and 300 to receive a cable of the hoist 75. A ledge 308 is secured to the lower end of the mast 70b to limit downward movement of the attachment plate 300.

The base plate 80b is formed with upper and lower flanges 88b and side plates 310 to strengthen the flanges 88b. A motor 82b is mounted on the upper flange 88b of base plate 80b and drives a shaft 84b through a right-angle drive gearbox 312 and coupling 314. The shaft 84b is supported in trunnion blocks 86b, one located adjacent the coupling 314 and one mounted on the lower flange 88b which also provides a thrust bearing to locate the shaft 84b.

The drive plate 100b forms part of a reciprocating drive enclosure 320 that is secured to the shaft 84b by mounting blocks 321 for rotation with the shaft. The enclosure 320 has a back provided by the drive plate 100b and sides 324, floor 326 and top 328. A slide assembly 117b includes slides 116b that are mounted on the drive plate 100b on either side of the shaft 84b. The slides 116b carry shoes 118b that are attached to a housing 120b that includes flanges 124b.

A shaker plate 130b has upper and lower ears 132b that are located between the flanges 124b with elastomeric bushings 134b are interposed between the flanges and ears. Hook 76b is welded to the shaker plate 130b between the ears 132b and projects outwardly between a pair of rails 340.

The rails 340 extend between the floor 326 and top 328 of the enclosure 320 and are spaced apart laterally to accommodate a pair of stop blocks 110b, 112b. The blocks 110b, 112b are secured to the rails 340 by bolts 342 that pass through one of a series of holes 344 to allow adjustment of the position of the blocks 110, 112 along the rails 340.

A pneumatic spring 152b is mounted on the lower mounting flange 332 of the enclosure 320 and has a piston rod 344 that is connected to the lower ears 132b of the shaker plate 130b. The piston rod 344 passes through the flange 124b for engagement with the lower ear 132b of the shaker plate 130b so that the spring 152b acts between the drive pate 100b and the shaker plate 130b. As the spring 152 is extended and retracted, it displaces the shaker plate 130b relative to the enclosure 320. The stroke of the spring 152b is slightly greater than the free movement between the blocks 110b, 112b and the hook 76b so that extension or retraction of the spring 152b moves the hook 76b into abutment with either of the blocks 110b, 112b.

Movement of the piston rod 344 is controlled by a pneumatic valve (not shown) that alternatively pressurises and vents the pneumatic spring 152b. The piston rod 344 extends under the application of pressure and retracts under the weight of the hook and component when vented to provide bodily displacement of the hook 76 relative to the enclosure 320 and base plate 80b and into abutment with the blocks 110b, 112b. Displacement of the hook 76 causes the component 10 to be bodily displaced in a vertical direction and abutment with the blocks 110b, 112b imparts an abrupt change of motion to the component 10. The movement of the hook 76 by the spring 152b is independent of the movement of the carriage assembly 74 along the mast 70b and therefore can continue as the component 10 is raised and lowered. The amplitude and period of the displacement is as described above with reference to the first embodiment of carriage assembly 74

The operation of the carriage assembly 74, will be described in detail below but it will be noted that the hook may be swung about a vertical axis by rotation of the shaft 84, and thereby move the component from one side of the mast 74 to the other. A swing arc of 180 degrees can be attained, allowing the component to be removed from the conveyor 21 and placed adjacent the fluidised bed 17. During the swinging of the hook 76 the transverse frame 45 and sled 66 may be moved on the gantry 20 to reduce the clearance required between the conveyor 21 and fluidised bed 17. During such movement, the carriage is moveable along the mast 70 for positioning of the component 10 relative to the fluidised bed 17, 19. Moreover, the drive to provide bodily movement, or shaking, of the hook 76 is supported on the drive plate 100 which in turn is rotated by the shaft 84. Therefore the hook 76 may be swung whilst the hook is being shaken to reduce cycle times in the fluidised bed 17, 19.

As can be seen generally in FIG. 1 and more specifically in FIG. 9, the fluidised beds 17, 19 are formed with upper and lower compartments or zones, 400, 402 respectively. The lower compartment 402 is enclosed on all four sides by walls 404 with a floor 406 that incorporates a fluidising air inlet and coating material supply in a conventional manner. A grid 408 is spaced above the floor 406 to protect the air and material supplies during use. The floor 406 is formed from a fibrous sheet that is held along its edges by a frame that is secured to the sidewalls 404. The membrane supports the coating material when it is not fluidized.

It is preferable that the coating powder can be removed from the lower compartment, either to change the coating material or to transfer the coating material to the adjacent fluidised bed if that is to be used for a different configuration of component. To facilitate the powder removal, the floor 406 is inclined to the horizontal plane and slopes downwardly toward an outlet 410 located in the side wall 404. The outlet 410 is generally horizontal to minimise the dead space below the outlet when the powder is removed.

The floor is inclined at an angle of 2° to 6° to the horizontal with an angle of 2° preferred. The sloping of the floor 406 is found to facilitate removal of the coating material from the lower compartment 402 when required by promoting a flow along the floor to the outlet 410. The upper limit of the slope is sufficiently low that the distribution of the coating material in the compartment 402 is not adversely affected and a substantially uniform depth of material is maintained across the compartment 402.

Different configurations of floor were tested, starting with a horizontal floor. The time required for powder removal was 6 minutes. The floor 406 was then inclined at an angle of 10° to the horizontal and a significantly improved drain time of 1.5 minutes was attained. However it was observed that the fluidisation in the bed was not uniform which adversely impacted the quality of the coating.

The angle of inclination was then reduced to 6° which provided a more uniform fluidisation but still exhibited a variation in coating thickness over the length of the component.

A further reduction to 2° was made which improved the fluidisation considerably and met stringent quality criteria. The time to empty the powder through the outlet 410 was reduced from 6 minutes to 3 minutes with the horizontal disposition of the outlet 410 minimising powder remaining in the compartment 402.

The upper compartment 400 is provided to hold the component 10 before and after coating has been applied and has side walls 410 with air intake filters 412 and a rear wall 414 with an air removal duct 416 with filters. The front wall 418 is formed from a pair of sliding doors 420 (FIG. 11 and 19) that slide laterally under the control of an operating mechanism 422 between open and closed positions as will be described more fully below.

The compartment 400 also contains a blow off apparatus 430 to remove excess material from the component 10 after coating. The blow off apparatus 430 includes three nozzle arrays, 432, 434, 436 located on front and rear sides of the compartments 400 respectively. The format of the arrays 432, 434, 436 will depend on the nature of the component 10 and the intricacies of the surface of the component 10. As shown in FIGS. 9 and 11, the array 432 is positioned at the upper edge of the front side wall 404 of lower compartment 402 so as to allow unimpeded access to the compartment 400. The component 10 is oriented so that the array 432 faces the planar outer surface 12 of the component 10. The array 432 has a single set of nozzles 433 supplied with air from air supply 441 (FIG. 11).

As seen in greater detail in FIG. 12, the array 434 is positioned on the rear face 414 of the upper compartment 400 so as to face the side of the component 10 with the frame 15, cross members 16 and seal retainer 18. As shown, the array 434 has four sets of nozzles 438, that extend across the compartment 400 from side to side and are placed to impinge upon an area of the component where coating is found to accumulate, such as the cross members 16. Each set of nozzles 438 is supplied by a manifold 440 (FIG. 13) that is connected to an air supply 441 by a respective control valve 442. The control valves 442 are individually controlled by a control unit 444 to supply the sets of nozzles 438 sequentially as the component is raised from the coating material. Again, the timing and duration of the blow off air through the nozzles 438 will depend on the nature of the component 10.

The manifolds 440 extend between vertical plates 446 secured to the side walls 410 and are connected to the plates 446 by bell cranks 450. The bell cranks 450 cover the ends of the manifold 440 to seal them and are connected to the side plates 446 by stub shafts 452. The shafts 452 are rotatable in the side plates 446 and the upper four of the of the stub shafts 452 are connected to a crank arm 454. At either end a slave link 456 is connected between the distal end of the crank arms 454 to ensure conjoint rotation of the stub shafts 452.

The array 436 consists of a set of nozzles 439 that is similar in construction to the set of nozzles 438 but is maintained in a fixed orientation by a keeper plate 458 secured to the side plates 446 and engaging a slot in the stub shaft 452. Like reference numerals will be used for the components of the array 436

Referring to FIGS. 14 and 15, each of the manifolds 440 consist of a tubular body 460 with a flange 462 at either end to connect to the respective bell cranks 450. A series of ports 464 are equally spaced along the longitudinal axis of the tubular body 460 for connection to respective ones of the individual nozzles 438, 439.

Each of the individual nozzles 438 has a body 466 with a through bore 468 corresponding to the diameter of the manifold body 460. The nozzle body 466 is split along a diameter of the bore 468 so the nozzle body can be clamped about the manifold 440. A spigot 470 is formed on the wall of the bore 468 and dimensioned to be received in a respective one of the ports 464.

A neck 472 projects from the nozzle body 466 with an internal duct 474 extending from the port 464 to a threaded boss 476 at the opposite end of the neck 472. The boss 476 receives a nozzle tip 478 which are fan shaped with an elongate outlet slit 480.

It will be noted that the neck 472 is formed in two different configurations, either a straight neck indicated at 472a or a cranked neck indicated at 472b on FIG. 12. The different necks 472 are arranged alternatively along the manifold 440 so that adjacent nozzle tips 478 are offset from one another to form two vertically spaced sets of nozzles 438. The boss 476 at the end of the neck 472 is also angularly offset in the horizontal plane with those on the straight neck 472a oriented in the opposite direction to those on the cranked neck 472b. The airflow from the nozzle tips 478 on each manifold 440 is thus presented as two vertically spaced bands of oppositely directed air.

The orientation of the manifolds 440 relative to the side frames 446 for the array 434 is controlled by a linear actuator 482. As shown in FIGS. 12 and 16, the actuator 482 is mounted behind the rear wall of the upper chamber 400 and is connected by a link 484 to a clevis 486 at the midpoint of one of the manifolds 440. Extension of the actuator 482 causes displacement of the manifold 440 away from the rear wall of the upper chamber 400, which in turn causes rotation of the stub shaft 452 in the side walls 446. The rotation of the stub shaft 452 is transferred to the slave link 456 to produce conjoint rotation of each of the upper four manifolds 440.

Similarly, retraction of the linear actuator causes movement of the manifold toward the rear wall of chamber 400 so that extension and retraction causes a sweeping movement of the air from the nozzle tips 478 over the surface of the component 10. Where the overall length of the manifolds or the number of manifolds warrants, a pair of actuators 482 may be used at spaced locations along the manifold. The actuators 482 are conjointly controlled to ensure uniform movement of the nozzles 478 across the array.

Because of the offset of the manifold 440 from the pivot axis of the stub shaft 452, as the manifolds 440 approach the component 10 from the retracted orientation shown in FIG. 17 to the extended position shown in FIG. 18, the nozzles 438 are moved to a more vertical orientation than if the manifold is simply pivoted to the side frame. The air flow is directed downwardly to maintain a wash across the surface of the component. This enables surplus material in re-entrant parts of the surface to be reached and removed.

The removal of the surplus material in the upper housing 400 creates a suspension of particulate material within the chamber that is preferably contained and recycled. To contain the suspension, the upper chamber 400 is enclosed by the pair of sliding doors 420 that are operated by the operating mechanism 422 to allow placement and removal of the component.

As can best be seen in FIG. 19-23, the doors 420 are each supported on a linear bearing 500 that consists of sets of caged balls 502 located within a cylindrical housing 504. The housing 504 extends about the front and two sides of the upper compartment 400 and is retained in the upper compartment by clips 506 at spaced intervals along the periphery of the compartment 400. Each of the doors 420 is suspended on ears 508 that project downwardly from respective ones of the sets of caged balls 502 so that the doors 420 are free to slide in either direction along the linear bearing 500 between open and closed positions.

Each of the doors 420 shown in FIGS. 24 and 25 consist of a flexible membrane 510, typically neoprene or rubber sheet, with aluminum panels 512 secured on either side of the membrane 510. The panels 512 are spaced apart along the axis of movement of the doors 420 to leave a narrow band of membrane 510 between each of the panels 512. This provides a living hinge defining a vertical axis about which the panels 512 may rotate to allow the door 420 to follow the path of the linear bearing 500 and at the same time provides a continuous barrier to inhibit efflux of the coating material. It has been found that a flexible sheet having a thickness of 4.76 mm with aluminum panels in the order of 3.175 mm thick, 122.24 mm wide with a gap of 6.35 mm between panels has proved satisfactory.

An outer aluminum panel 514 is secured to the outermost panel 512 and is offset on the vertical edge so that the panel 514 overlies the spacing of the panels 512 and protects the sheet 510. A flexible D-ring 515 extends along a vertical edge of the door 420 to provide a seal against the other door in a closed position.

Movement of the doors 420 is controlled by the operating mechanism 422 which includes a motor 516 mounted above the compartment 400. The motor 516 is connected to a right angle gearbox 518 that drives a spindle 520 located within the compartment 400 aligned with and above the linear bearing 500. A pinion 522 is mounted on the spindle 520 and engages a pair of racks 524. The racks 524 are located on opposite sides of the pinion 522 and extend in opposite directions parallel to the linear bearing 500.

The racks 524 are carried by door slides 526 that in turn are mounted on linear bearing 528 connected to the roof of compartment 400. Rotation of the pinion 522 causes the racks 524 to slide on the linear bearings 526 in opposite directions and by equal distances.

A hanger 530 is connected at one end of each of the slides 526 and has a leg 532 projecting downwardly to one side of and below the linear bearing 500. A pivoted link 534 is located at the lower end of the leg 532 and the other end of the link 534 is pivotally connected to the leading edge of respective ones of the doors 420 so that movement of the racks 524 is transferred through the hanger 530 and link 534 to the door.

A ceiling 536 is located in the upper compartment 400 below the hangers 530 to divide said upper compartment 400 in to an upper cavity 401 and a lower cavity 403. The operating mechanism 422 and the linear bearing 500 are located in the upper cavity above the ceiling 536. An open track 538 is provided in the ceiling 536 that follows the path of the linear bearing 500 and allow passage of the ears 508 to support the doors 420. The track 538 is sealed with a brush type seal 540 to inhibit flow of coating material to the volume above the ceiling 536.

The lower edge of the door 420 is secured by ears 542 to a guide 544 to maintain the vertical orientation of the door 420.

To transfer the components 10 from the conveyor 21 to the fluidized bed 17, the component 10 is positioned on the conveyor 21 within the gantry 20. Whilst in that position the trolley 24 is in an environment that potentially has significant coating material in suspension. The encapsulation of the rollers 26 and the caps 614, 620 inhibits the build up of the coating material on the trolley 24.

The mast assembly 74 is then positioned on the gantry 20 so that the hook 76 is located within the aperture 35. The hoist 75 is operated to move the hook 76 into engagement with the head 34 and lift the hanger 32 off the arm 28. As the hook 76 is raised, the sway bar 77 enters the slot 41 to hold the head 34 between the bosses 78 and inhibit swinging relative to the hook 76. The mast assembly 70 is then moved along the rails 43, 47 and the hook 76 rotated by the carriage assembly 74 about a vertical axis until the component 10 is aligned with the opening in the fluidized bed 17. During the repositioning, the mast assembly 70 moved relative to the gantry 20, as described above, to reduce the spacing necessary between the conveyor 21 and the fluidised beds 17, 19.

The engagement of the sway bar 77 with the head inhibits swinging of the component 10 on the hook 76 and provides for a stable transfer of the component. The sway bar is engaged as the hook is lifting the head so does not require intervention, and similarly, can be released when the component is replaced on the conveyor 21.

The hook 76b is rotated by the motor 82b rotating the shaft 84b and moving the reciprocating drive enclosure 320. The shaker plate 130b moves with the enclosure 320 to swing the hook 76.

The doors 420 are retracted to the open position by operation of the motor 440 which rotates the pinion 522 and moves the racks 524 away from each other. The link 534 moves the door along the linear bearing 500 so it moves along the sides of the upper compartment 402 and provides maximum opening to the upper compartment.

The transverse frame 45 is advanced to place the component 10 within the upper compartment 402. The array 432 is fixed to the front wall below the opening for the doors 420 so as not to impinge ingress or egress of the component 10. The doors 420 are then closed by rotating the pinion 522 in the opposite direction to move the racks 524 toward and past one another. The link 534 pulls the doors 420 along the linear bearing 500 with the living hinges accommodating movement around the curved portion of the bearing. The motor 516 operates until the leading edges of the doors 420 abut in a closed position with the flexible D-ring 515 on the edges of the sheet 510 flexing around the hook 76 to contain the environment within the fluidised bed 17.

With the component positioned in the upper compartment 402, the hoist 75 is used to lower the carriage assembly 74 along the mast assembly 70 into the lower compartment 400. The flexibility of the D-rings 515 allows the hook 76 to slide between the edges of doors 420 and remain under the control of the hoist 75.

As the component is lowered in to the lower compartment 400, it is immersed within the fluidised coating material for the required time before the hoist 75 is reversed and the component withdrawn. The lowering and subsequent removal of the component 10 must be done relatively quickly with the immersion in the order of 30 seconds to maintain the uniform thin coating required.

As the component 10 is immersed in the coating material, the hook 76 is shaken by operation of the motor 152b. The hook 76 is bodily displaced vertically as described above and abuts the stops 110, 112 to impart rapid changes of motion or shocks to the component carried on the hook 76. The shaking of the hook 76 continues as the component is lifted from the lower compartment 402. The shaking has been found to encourage the penetration of the coating into the complex surface features of the component 10.

Movement of the component upwardly activates the blow off apparatus 430 to supply air to the manifolds 440 and through the nozzles 432, 434. The air flow from the nozzles 432, 434 removes excess coating material and can be selectively switched on and off depending on the nature of the component. The hoist 75 may also be used to raise and lower the component over relatively small excursions to assist the removal of excess material and to complement the action of the motor 152b in encouraging penetration of the coating.

As the component 10 moves out of the lower compartment 402, the air from the array 432 impinges the front face of the component to remove excess material. The front face 12 is relatively smooth in the case of a door and so a single fixed array is sufficient to remove the material in a uniform manner.

The rear face of component 10 has weldments and fixtures as discussed above so that coating material may be held in corners or along join lines. To remove the excess material, the array 434 is supplied with air from the manifold 440. The air may be supplied simultaneously to all nozzles or can be operated sequentially as the component 10 moves past.

The lowermost manifold is fixed and accordingly it supplies a stream of air that impinges on the rear of the component 10 as two spaced bands in a fixed orientation.

The upper four manifolds are adjustable and each set of nozzles 438 provide two bands of air that initially impinge the component normal to the rear face. In order to access areas where coating may accumulate, the actuator 482 is extended causing the orientation of the nozzles 438 to be progressively inclined to the rear surface. At the same time, the mounting of the manifolds on the bell cranks 450 causes the nozzles 438 to move toward the rear face as the nozzles downwardly incline to reach behind any fixtures and weldments. The two bands of oppositely directed air streams effectively scour any accumulations and remove excess material.

The operation of the nozzles may occur as the component is being lifted from the lower compartment 402 but to ensure effective removal it has been found that a reduction in vertical speed or holding the component stationary is preferred. This of course is facilitated by the control provided by the arrangement of the hoist 75.

With the excess coating removed, the actuator 482 is reversed to retract the manifolds 440, the doors are opened and the gantry operated to remove the component 10. The component may be repositioned for application of a second coating in the fluidised bed 19, or returned to the conveyor 21. When the component is returned to the conveyor, the hanger 32 is positioned so the notch 30 on the arm 28 is in the aperture 35. The hoist is then lowered to release the hook from the head 34 and remove the sway arm 77 from the slot 41 and the hook retracted.

The component may then be moved along the conveyor 21 and a further component 10 positioned for coating.

It will be seen therefore that the handling and coating of the component is performed in an efficient, flexible manner that provides a uniform coating with removal of excess material in a contained environment. The component is controlled during movement between conveyor and fluidised bed to reduce the footprint required for the apparatus and minimise human intervention. It will be appreciated that the operation of the motors to effect movement of the mast in the gantry, the hoist, and the carriage assemblies is controlled by conventional programmable logic that has not been described in detail as such controls are varied and well known to attain the functionality required.

1. A coating apparatus including a first compartment to receive a component to be coated, a second compartment below said first compartment to contain a coating material, a carriage assembly to lower said component from said first compartment to said second compartment for application of coating and to lift said component from said second compartment after application of coating, and a blow off apparatus to remove excess coating material from component, said blow off apparatus including a first array of nozzles in said first compartment to project a fluid toward said component as it is raised from said second compartment to remove excess coating material from said component, said first array of nozzles including at least one set of nozzles mounted to oscillate and vary the direction of projection of said fluid toward said component.

2. A coating apparatus according to claim 1 wherein said first array of nozzles comprises a plurality of sets of nozzles, each of said sets being arranged at vertically spaced locations in said first compartment and each arranged to oscillate.

3. A coating apparatus according to claim 2 wherein said sets of nozzles of said first array oscillate conjointly.

4. A coating apparatus of claim 2 wherein each set of nozzles of said first array is operated to project fluid sequentially as said component is raised from said second component.

5. A coating apparatus according to claim 1 wherein said first compartment has a door to allow ingress and egress of said component and a second array of nozzles is disposed in said first compartment to one side of said doors to allow passage of said component in to said first compartment through said doors.

6. A coating apparatus according to claim 5 wherein said first array of nozzles is located on an opposite side of said first compartment to said second array whereby at least one array is provided on either side of said component.

7. A coating apparatus according to claim 6 wherein a third array of nozzles is located in said first compartment adjacent to said first array.

8. A coating apparatus according to clam 7 wherein the direction of projection of fluid from said second array and said third array is fixed.

9. A coating apparatus according to claim 1 wherein each set of nozzles of said first array oscillates about an axis of rotation transverse to the direction of movement of said component.

10. A coating apparatus according to claim 1 wherein each set of nozzles of said first array is supported on side walls of said first compartment for oscillation about said axis of rotation.

11. A coating apparatus according to claim 10 wherein said nozzles of each set of nozzles of said first array are offset from the axis of rotation.

12. A coating apparatus according to claim 11 wherein nozzles of each set of nozzles are mounted on a manifold and said manifold is connected to said side walls by a bell crank that is pivoted to supports on said side walls.

13. A coating apparatus according to claim 12 wherein said bell cranks are connected to one another by a slave link for conjoint rotation of said sets of nozzles.

14. A coating apparatus according to claim 13 wherein an actuator acts on one of said manifolds to induce rotation of said bell crank about said axis of rotation and cause a corresponding rotation of the other of said manifolds of said first array.

15. A coating apparatus according to claim 14 wherein said actuator is located outside said first compartment and is connected to said one of said manifolds by an operating link.

16. A coating apparatus according to claim 8 wherein said nozzles of each set have two different configurations and said configurations alternate along said manifold.

17. A coating apparatus according to claim 16 wherein said nozzles of a first configuration are elevated above nozzles of a second configuration to provide vertically spaced fluid flows toward said component.

18. A coating apparatus according to claim 17 wherein nozzles of each configuration are inclined in a transverse direction relative to said component with said nozzles of said first configuration being oppositely inclined to nozzles of said second configuration.

19.-34. (canceled)
